(19) United States
(12) Patent Application Publication
(10) Pub. No.: US 2009/0048396 A1
(43) Pub. Date: Feb. 19, 2009

(54) Emulsion separator

(75) Inventor: Hans Gunter Alexander Waltl, North Yorkshire (GB)

Correspondence Address: SCHWEGMAN, LUNDBERG & WOESSNER, P.A., P.O. BOX 2938, MINNEAPOLIS, MN, 55402, US

(73) Assignee: PSI GLOBAL LTD., DURHAM (GB)

(21) Appl. No.: 11/887,086

(22) PCT Filed: Apr. 11, 2006
(86) PCT No.: PCT/GB2006/050082

§ 371 Date: Sep. 25, 2007

(30) Foreign Application Priority Data
Apr. 13, 2005 (GB) 0507468.7

(51) Int. Cl. B01D 17/04; F04B 39/16; C02F 1/40

(52) U.S. Cl. 525/55; 210/307; 210/205

(57) ABSTRACT

Apparatus is provided for separating oil from compressor condensate. It comprises a separator having an upper chamber provided with a condensate inlet and a filter housing containing a hydrophobic oleophilic substance so that in use condensate flows from the upper chamber through the filter housing under the action of gravity. The upper chamber contains a coalescing filter connected with the condensate inlet. In an alternative structure, a holding tank is series connected with a separator, and means is provided for supplying a de-emulsifying agent to condensate in the holding tank before the condensate is supplied to the separator. The above apparatus can carry out a method which comprises mixing the condensate with de-emulsifying agent, holding the mixture while emulsion cracking at least partly proceeds, and supplying the at least partly cracked emulsion to a separator containing a hydrophobic oleophilic substance.

This invention relates to a separator, and in particular to a separator for use in removing oil from the condensate produced by an air compressor.

The condensate produced during the operation of an air compressor tends to be contaminated with oil, for example the lubricating oil of the compressor. The presence of the contamination causes difficulties in disposing of the condensate. It is therefore desirable to be able to separate the oil from the condensate, and one way of achieving this is to store the condensate in a large reservoir for a sufficiently long period to allow the oil to separate from the condensate by differential density. However, such a technique has the disadvantage that, where large quantities of condensate are produced, the reservoir must be of large capacity, and occupies a large area of floor space.

GB-B-2355942 disclosed a separator for use in separating oil from the condensate produced during the operation of a compressor, the separator comprising a reservoir and a filter housing containing a hydrophobic oleophilic substance, and wherein fluid from the reservoir flows through the filter housing, in use, under the action of gravity. The provision of such a separator avoids the necessity to provide a large reservoir or separation tank which occupies a large area.

It is an object of the invention to further improve the separator.

In one aspect the invention provides apparatus for separating oil from compressor condensate, comprising a separator having an upper chamber provided with a condensate inlet and a filter housing containing a hydrophobic oleophilic substance so that in use condensate flows from the upper chamber through the filter housing under the action of gravity, wherein the upper chamber contains a coalescing filter connected with the condensate inlet.

In an alternative aspect, the invention provides apparatus for separating oil from compressor condensate, comprising a holding tank series connected with a separator, wherein means is provided for supplying a de-emulsifying agent to condensate in the holding tank before the condensate is supplied to the separator. In a preferred embodiment the holding tank is provided with a first supply line for delivering de-emulsifying agent and a second supply line for compressed air for agitating the contents of the holding tank.

In a third aspect the invention comprises a method of treating compressor condensate which comprises mixing the condensate with deemulsifying agent, holding the mixture while emulsion cracking at least partly proceeds, and supplying the at least partly cracked emulsion to a separator containing a hydrophobic oleophilic substance.

How the invention may be put into effect will now be described, by way of example only, with reference to the accompanying drawings, in which:

FIG. 1 is a simplified block diagram of a compressor system including a separator in accordance with an embodiment of the invention;

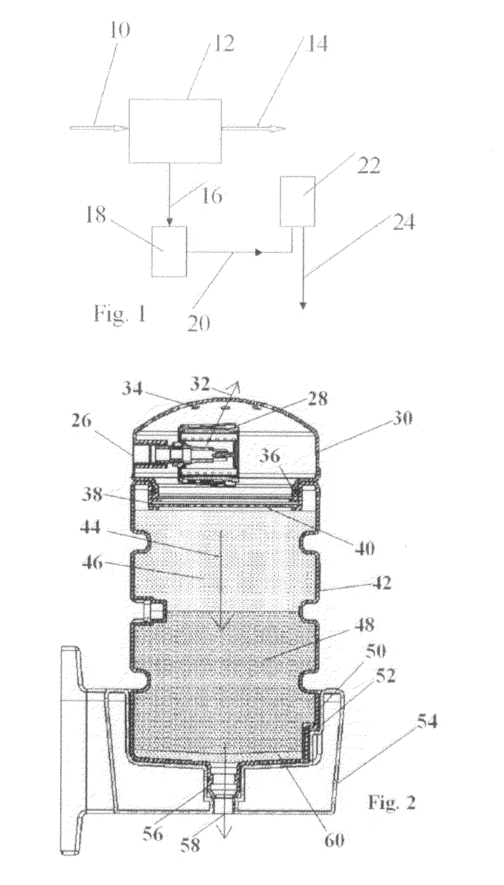

FIG. 2 is a sectional view of a first embodiment of a separator according to the invention; and

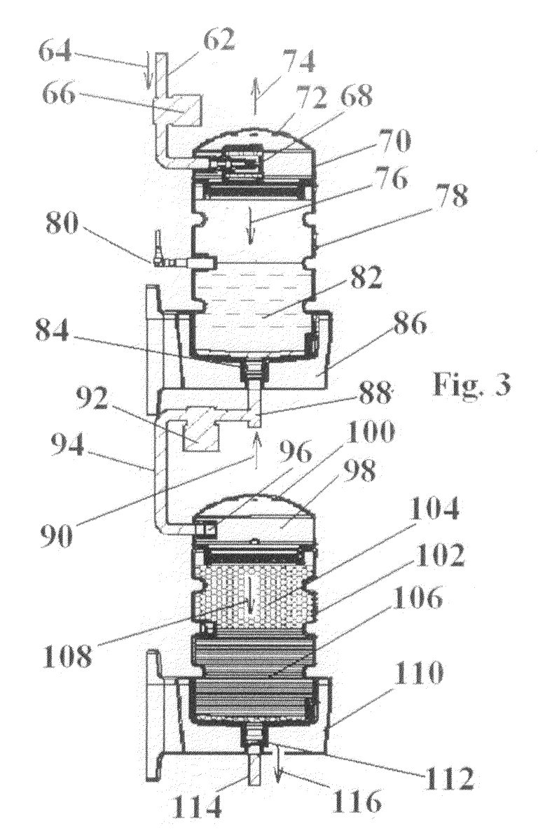

FIG. 3 is a sectional view of a second embodiment of a separator according to the invention.

The compressor system illustrated diagrammatically in FIG. 1 is intended to supply compressed air e.g. to a plurality of machines driven by compressed air. The system comprises inlet passage 10 through which air is drawn into a compressor 12 supplying compressed air to outlet passage 14. During operation a quantity of water condenses in the compressor 12, and the condensate flows under pressure through flow line 16 to a small holding tank 18. There is a likelihood that the condensate will include, as well as water, a quantity of oil emulsified in the water which, as previously stated must be removed from the remainder of the condensate prior to disposal of the condensate.

In order to separate the oil from the remainder of the condensate, the contents of holding tank 18 are supplied periodically by means of a pump (not shown) and flow line 20 to separator 22. The supply of condensate from the holding tank 18 to the separator 22 may occur at fixed intervals, the pump being controlled by a timer. Alternatively a level sensor may be used to determine when the condensate within the holding tank has reached an appropriate depth, after which a signal is sent to a pump control to cause the condensate to be pumped into the separator. Gas in vented from the separator which works at or substantially at ambient pressure, oil becomes retained within the separator and water of a low oil content is discharged through flow line 24. Typically the untreated condensate will be so opaque that it is not transparent, whereas the treated condensate is almost as transparent as water with only a faint cloudiness.

In a first embodiment of the invention, the condensate passes to oil/water separation apparatus having a coalescing filter series-connected to a separator at least partly filled with a medium that retains oil and permits water to pass.

In FIG. 2, condensate passes from a delivery line to entrance port 26 leading via an internal delivery line to the interior of a coalescing filter 28, where air or gas escapes upwardly as indicated by arrow 32 and coalesced droplets of condensate pass downwardly by gravity into media 46,48 as shown by arrow 44. The coalescing filter 28 is a closed hollow tubular structure having a single inlet and having two working components, a layer within which the oil droplets coalesce and a drainage layer which collects the oil leaving the coalescing layer and retains it until it drips by gravity from the filter. The coalescing layer may be of borosilicate glass microfibres, see GB-A-1603519. The drainage layer may be provided by a porous sleeve of plastics foam or by a non-woven fabric. Coalescing filters are further discussed in WO 89/07484 and WO 99/58319. Such filters are commonly incorporated into so-called “filter silencers” and devices of this type incorporate a coalescing filter in an open cage structure and are available from PSI Global, although the use of a collection bowl may not be necessary. However, the cartridge types that have been used in filter silencers have been found suitable, with only slight adaptation, for use in the invention. For effective oil distribution, and to save height, the coalescing filter 28 is used with its axis horizontal, i.e. at right angles to the axis of the separator with which it is in series. When viewed in profile, the coalescing filter in use then has a lower liquid-saturated region occupying some 90° from which coalesced condensate drips, and an upper relatively dry region occupying some 270° from which air or other gas can escape. The whole of the condensate received at entrance port 26 passes through the coalescing filter 28.

The entrance port 26 leads into and the filter 28 is contained within a hollow cap 30 of the separator unit, where air and water become separated. Air vents through apertures 34 in an upper surface of the cap 30 and coalesced condensate flows by gravity into a separator cartridge 42, the cap 30 having a downwardly directed liquid discharge port 36 defined by a spigot that fits into a socket type inlet port 38 for separator cartridge 42. For improved liquid distribution, a perforated plastics distribution plate 40 fits across the inlet port 38. About the upper half the volume of the cartridge 42 is occupied by a body 46 of polyester foam that further assists distribution of condensate, and about the lower half is occupied by a hydrophobic oleophilic oil retention medium that may be of fibrous or shredded polypropylene. A suitable material is CA5.9003-07-0, but it will be appreciated that other materials having suitable oil-retentive properties may also be used.

The use of a coalescing filter both reduces unwanted condensate passing through the apertures 34 to soil the exterior of the apparatus, and it also spreads the condensate across the downstream media 46,48, so that flow of liquid is at least at first mainly close to the axis of the separator 42. The cylindrical sidewall is in-turned at axially spaced intervals as shown to reduce the risk of liquid flow along the sidewall effectively by-passing the media 46,48.

The base 50 of separator 42 fits into socket 52 of a support 54 which may be configured e.g. for fixing to a wall with the axis of the separator 42 upright as shown. The base is formed with a through-hole for receiving separator outlet 56 which is provided by a threaded tube which may provide a connection for a hose or other line leading to a drain. Purified condensate leaves the separator 42 as indicated by arrow 58, and as virtually the hole of the oil content is retained, the cleaned condensate may be passed direct to a foul sewer without the need for an additional filter. As previously explained the condensate draining form the separator 42 should be substantially free of haze and this may be used to check whether the separator is still operative or whether it has become filled with oil and is due for replacement. Alternatively blue oil-in-water test papers may be used to confirm that the separator is still operative.

The above embodiment works most effectively for condensates that separate quickly into an oil phase and a water phase. If the emulsion is stable, then it is desirable to break the emulsion, or at least initiate emulsion breakage, before it is presented to the separator. FIG. 3 shows a second embodiment of the invention, the condensate passing via a coalescing filter to a holding tank where it may be treated with emulsion breaking agents and then passing to oil/water separation apparatus having an optional coalescing filter and a separator at least partly filled with a medium that retains oil and permits water to pass.

In FIG. 3, a wall support 86 provides support for a holding tank 78 provided with a cap 70 and corresponding to the holding tank 18 of FIG. 1 except that it also acts as an emulsion splitter. Condensate from the compressor passes via supply line 62 to valve 66 as indicated by arrow 64, and if the valve is open thence to coalescing filter 68 within the cap 70. The coalescing filter is generally as described above and provides a stream of gas as indicated by arrow 74 which rises through apertures 72 of the cap, and a flow of coalesced condensate indicated by arrow 76 which accumulates as a pool 82, the holding tank drain valve 92 being closed. Level sensor monitors the level of condensate in the pool 82.

When the pool 82 has reached an appropriate level, e.g. half the height of the tank 78, the valve 66 is closed. Demulsifying agent and air are introduced from the base into the pool 82 via line 88 as indicated by arrow 90, the condensate inlet valve 66 and the holding tank drain valve 92 both being closed, and the air serving to mix the demulsifying agent and the condensate. Various demulsifying agents may be used depending on the nature of the particular emulsion which in turn will be related to the oil used in the compressor and the conditions under which the compressor is operated, and also what materials may be allowed to enter the drain or foul sewer. Examples of possible inorganic demulsifiers are salts of divalent and trivalent metals, such as calcium chloride, calcium oxide, aluminium chloride, aluminium sulphate and iron sulphate. Examples of possible organic demulsifiers are polyamines, polyamidoamines, polyimines, polyether-polyamines, quaternised polyamines, quaternised polyamidoamines, homopolymers, copolymers and terpolymers based on acrylic acid and acrylamide, homopolymers, copolymers and terpolymers of diallyldimethylammonium chloride and mixtures of such demulsifiers. Such inorganic and organic demulsifiers are known per se. Agitation may be by compressed air at 3 barg.

After addition of demulsifier is complete and an appropriate mixing time has elapsed, the supply of compressed air is discontinued and the condensate is allowed to stand for a period during which demulsification proceeds at least partly towards completion e.g. for about 5 minutes. Drain valve 92 is then opened, permitting the condensate to drain by gravity from the holding tank 78 to a separator unit which is generally the same as the separator of FIG. 2. Drain line 94 leads from valve 92 to inlet 96 of separator cap 98 which in the drawing does not have a coalescing filter but which may be provided with a filter like the filter 68. Any air escapes through cap apertures 100, and condensate passes downwards through foam medium 104 and polypropylene or other oil-retentive medium 106 of separator 102 as indicated by arrow 108. Stand 110 supports the separator 102, and separator outlet 112 permits treated condensate to flow to drain hose 114 as indicated by arrow 116. On completion of the cycle, drain valve 92 is closed and inlet valve 66 is re-opened to permit fresh condensate to enter holding tank 78 under the control of level sensor 80. Operation is controlled by a control unit (not shown) to which the valves 66, 92 and level sensor 80 are operatively connected.

The working parts of the above apparatus may be made entirely of plastics and may be recyclable. Furthermore, the major components of the holding tank and the separator may be made of the same dimensions and materials and are interchangeable. The design is compact and suitable for wall-mounting so that floor area need not be lost. The oil coalescing filter and the separator cartridge are easily replaceable, and maintenance between system changes is minimal. Use of filter membranes, carbon filters and other relatively complex and expensive equipment is avoided.

It will be appreciated that various modifications may be made to the embodiments described above without departing from the invention.

1-8. (canceled)

9. Apparatus for separating oil from compressor condensate comprising:
a hollow cap,
an inlet into the interior of said cap for compressor condensate;
a tubular coalescing filter connected to the inlet so that condensate passes from said inlet directly into the interior of the filter and air and coalesced oil/water pass to the exterior of the filter;
at least one aperture at the top of the cap for providing a vent path for air from said cap;
a downwardly directed discharge part at the base of the cap for providing a gravity flow path from the cap for the separated oil/water of said condensate;
a separator cartridge for receiving the separated oil/water from the condensate, said separator cartridge containing a hydrophobic oleophilic substance for substantially retaining oil and allowing downward flow of water;
the discharge part of the cap either being connected directly to an inlet part for the separator cartridge or being connected to an inlet port of a holding tank having an outlet that leads to an inlet port of the separator cartridge.

10. The apparatus of claim 9, wherein the coalescing filter has a horizontal axis that is at right angles to the axis of the separator cartridge.

11. The apparatus of claim 9, wherein the coalescing filter comprises an oil coalescing layer of a microfibrous material and a second layer of a drainage material located downstream of the coalescing layer, said drainage layer being for receiving condensate from the coalescing layer and providing a path for condensate to flow by gravity from the coalescing filter.

12. The apparatus of claim 9, wherein the hydrophobic oleophilic substance comprises polypropylene.

13. The apparatus of claim 9, wherein means are provided for supplying a deemulsifying agent to the condensate in the holding tank before the condensate is supplied to the separator cartridge.

14. The apparatus according to claim 13, wherein the holding tank is provided with a first supply line for delivering deemulsifying agent and a second supply line for compressed air for agitating the contents of the holding tank.

15. A method of treating compressor condensate which comprises mixing the condensate with deemulsifying agent, holding the mixture while emulsion cracking at least partly proceeds, and supplying the at least partly cracked emulsion to a separator cartridge containing a hydrophobic oleophilic substance.

16. The method of claim 15, wherein said substance is polypropylene.

17. Apparatus for separating oil from compressor condensate comprising:
a hollow cap,
an inlet into the interior of said cap for compressor condensate;
a tubular coalescing filter connected to the inlet so that condensate passes from said inlet directly into the interior of the filter and air and coalesced oil/water pass to the exterior of the filter, wherein the coalescing filter has an axis;
at least one aperture at the top of the cap for providing a vent path for air from said cap;
a downwardly directed discharge part at the base of the cap for providing a gravity flow path from the cap for the separated oil/water of said condensate;
a separator cartridge for receiving the separated oil/water from the condensate, said separator cartridge containing a hydrophobic oleophilic substance for substantially retaining oil and allowing downward flow of water, wherein the axis of the coalescing filter is at a right angle to an axis of the separator cartridge;
the cap including a discharge part connected directly to at least one of an inlet part for the separator cartridge and an inlet port of a holding tank having an outlet that leads to an inlet port of the separator cartridge; and
wherein the coalescing filter comprises an oil coalescing layer of a microfibrous material and a second layer of a drainage material located downstream of the coalescing layer, said drainage layer being for receiving condensate from the coalescing layer and providing a path for condensate to flow by gravity from the coalescing filter.

18. The apparatus of claim 17, wherein the hydrophobic oleophilic substance comprises polypropylene.

19. The apparatus of claim 17, wherein a deemulsifying agent supply fluidly connected to the condensate in the holding tank to supply demulsifying agent before the condensate is supplied to the separator cartridge.
